(19) United States
(12) Patent Application Publication
(10) Pub. No.: US 2007/0085421 A1
(43) Pub. Date: Apr. 19, 2007

(54) ELECTRICAL INSTALLATION FOR COUPLING A POWER SUPPLY SYSTEM AND A CENTRAL DIRECT CURRENT BRANCH AND METHOD FOR OPERATING AN INSTALLATION OF THIS TYPE

(75) Inventor: Oliver Drubel, Pegnitz (DE)

Correspondence Address: DARBY & DARBY P.C., P. O. BOX 5257, NEW YORK, NY, 10150-5257, US

(73) Assignee: Alstom Technology Ltd., Baden (CH)

(21) Appl. No.: 11/537,833

(22) Filed: Oct. 2, 2006

Related U.S. Application Data
(63) Continuation of application No. PCT/EP05/51341, filed on Mar. 23, 2005.

(30) Foreign Application Priority Data
Mar. 30, 2004 (DE) 10 2004 016 034.1

(51) Int. Cl. H02J 1/10

(52) U.S. Cl. 307/43

(57) ABSTRACT

An electrical installation includes a power supply network, an AC/DC converter, a central DC branch, and a rotating mass energy store. The power supply network is connectable to the central DC branch selectively via one of the AC/DC converter and the rectifier bridge. The rotating mass energy store is connectable to the central DC branch selectively via one of the AC/DC converter and the rectifier bridge and connectable directly to the power supply network. In addition, a method for operating of the electrical installation includes selectively connecting the rotating mass energy store according to a status of the power supply network to the central DC central branch via one of the AC/DC converter and the rectifier bridge and directly to the power supply network

This application is a continuation of International Application No. PCT/EP/2005/051341, having an international filing date of Mar. 23, 2005, which was published as WO 2005/096467 on Oct. 13, 2005, and which claims priority to German Patent Application No. 10 2004 016 034.1, filed on Mar. 30, 2004. The entire disclosure of both applications is incorporated by reference herein.

The invention relates to the field of power supply networks. It concerns an electrical installation for coupling a power supply network and a central DC branch. It also refers to a method for operating an installation of this type.

### BACKGROUND

In recent years, power supply networks or energy distribution networks have been increasingly affected by what are called “blackouts”. These “blackouts” are caused mainly by the malfunctioning of parts of the installation in conjunction with the transmission of power over great distances. Furthermore, the circumstances of the energy distribution are changing from a combination of energy generation that can be easily controlled and energy consumption that can barely be controlled to a combination of energy generation that cannot be controlled, e.g. wind-energy, and uncontrolled energy consumption. This new situation requires economic energy store systems with low efficiency losses. To be able to cope with this situation, more and more storage systems have to be introduced into the power supply network. The effectiveness of such measures depends not only on the efficient storage of energy but also on the topology of the network systems.

### SUMMARY OF THE INVENTION

An object of the invention is to provide an electrical installation for coupling a power supply network and central DC branch, by means of which the stability of the network can be improved in a simple and particularly effective manner, and to provide a method for operating an installation of this type.

The present invention includes an electrical installation in which a power supply network can be selectively connected via an AC/DC converter or a rectifier bridge to at least one central DC branch. To stabilize the power supply network, a rotating mass energy store is provided that can be selectively connected via the AC/DC converter or the rectifier bridge to the at least one central DC branch or directly to the power supply network. The rotating mass energy store that can be connected to the central DC branch or directly to the power supply network according to demand and network conditions, by means of either the AC/DC converter or the rectifier bridge as required. In this case, it is possible to inject either the real or wattless power as required from the rotating mass energy store into the network, or to take the real power from the central DC branch or to supply it to the central DC branch. The central DC branch in this case can be part of a (larger) DC network.

According to one preferred arrangement of the invention, the rotating mass energy store includes a rotating mass that is selectively coupled to a synchronous machine operating as a motor or generator.

Suitable switches are provided for the selective connection of the power supply network and the rotating mass energy store to each other or to the central DC branch.

The synchronous machine of the rotating mass energy store is connected to the other parts of the electrical installation is achieved especially by means of a transformer.

A further preferred arrangement of the installation according to the invention is characterized by smoothing capacitors being arranged at the output of the rectifier bridge. In addition, a DC energy storage element, especially in the form of a superconducting coil or capacitor bank, can be connected to the central DC branch.

In a further arrangement of the invention, at least one wind-energy installation, that can be selectively connected to the rotating mass energy store, is provided in parallel with the rotating mass energy store, with the at least one wind-energy installation including a wind turbine coupled to an asynchronous machine and suitable switches being provided for the selective connection of the wind-energy installation to the rotating mass energy store.

One preferred arrangement of the method according to the invention is characterized in that the rotating mass energy store is connected to supply wattless power to the power supply network, and in that the power supply network supplies real power via the rectifier bridge to the central DC branch.

A further preferred arrangement of the method according to the invention is characterized in that the rotating mass energy store supplies real power via the rectifier bridge to the central DC branch, and in that real power is supplied via the AC/DC converter from the central DC branch to the power supply network.

A further preferred arrangement of the method according to the invention is characterized in that real power is supplied from the central DC branch via the AC/DC converter to the rotating mass energy store, and in that the power supply network supplies real power via the rectifier bridge to the central DC branch.

Furthermore, it is feasible for both the power supply network and the rotating mass energy store to supply real power via the rectifier bridge to the central DC branch.

It is also possible for both the power supply network and the rotating mass energy store to be supplied with real power from the central DC branch via the AC/DC converter.

In conjunction with a wind-energy installation, it is especially advantageous if the rotating mass energy store supplies wattless power to the at least one wind-energy installation. Also it is advantageous if the rotating mass energy store is first started from the central DC branch via the AC/DC converter and then connected to the at least one wind-energy installation.

### BRIEF DESCRIPTION OF THE DRAWINGS

The invention will be explained in more detail using exemplary embodiments in conjunction with the drawings, in which:

FIG. 1 shows a simplified circuit diagram of an electrical installation according to a first preferred exemplary embodiment of the invention, with the power supply network and the rotating mass energy store connected directly to each other and exchanging wattless power and the power supply network supplying real power to a central DC branch via a rectifier bridge;

FIG. 2 shows the installation from FIG. 1 with the power supply network receiving real power from the central DC branch and the rotating mass energy store supplying real power to the central DC branch;

FIG. 3 shows the installation from FIG. 1 with the rotating mass energy store receiving real power from the central DC branch and the power supply network supplying real power to the central DC branch;

FIG. 4 shows the installation from FIG. 1 with the rotating mass energy store and the power supply network supplying real power to the central DC branch;

FIG. 5 shows the installation from FIG. 1 with the rotating mass energy store and the power supply network receiving real power from the central DC branch;

FIG. 6 shows a simplified circuit diagram of an electrical installation according to a second preferred exemplary embodiment of the invention with at least one wind turbine being arranged in parallel with the rotating mass energy store; and

FIG. 7 shows the installation from FIG. 6 with the rotating mass energy store being first started from the central DC branch.

### DETAILED DESCRIPTION

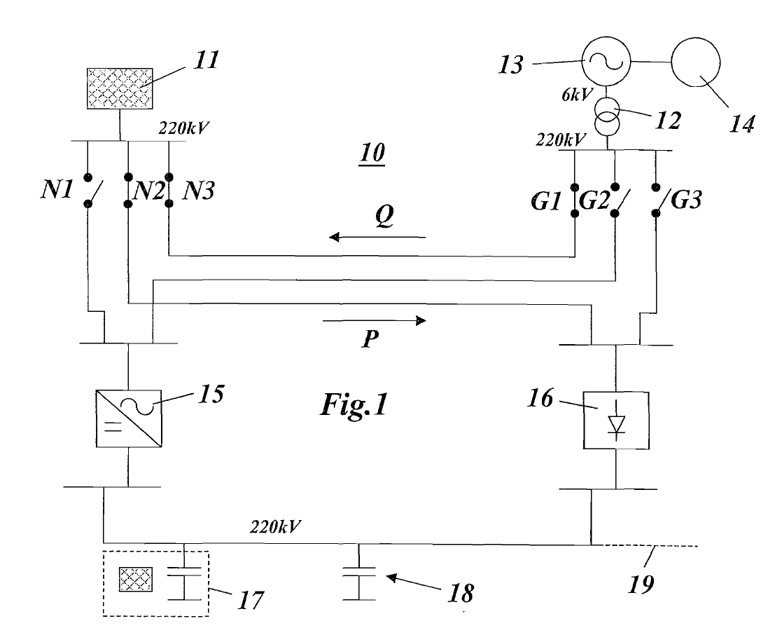

FIGS. 1 to 5 show the same preferred exemplary embodiment of an electrical installation according to the invention. The process carried out by the installation is different in the individual figures, and in each case results from the different settings of the switches used.

The electrical installation 10 of FIGS. 1 to 5 includes a coupling between a power supply network 11 (shown symbolically as a cross-hatched block) and one (or more) central DC branch(es) (DC backbone) 19 which are only indicated. Both the power supply network 11 and the central DC branch 19 are in this example at a 220 kV level. Other voltage levels are also conceivable. The central DC branch 19 can establish a connection to other networks. It can also itself be part of a DC network.

An AC/DC converter 15 is connected by its input to the central DC branch 19 and by its output to a rectifier bridge 16. By means of the network switches N1, N2, the power supply network 11 can selectively draw power via the AC/DC converter 15 from the central DC branch 19 or supply power via the rectifier bridge 16 to the central DC branch 19. Smoothing capacitors 18 are provided for smoothing at the central DC branch 19 end. A conventional DC storage element 17, e.g. in the form of a superconducting coil or capacitor bank can be connected can also be connected, for energy store.

To stabilize the power supply network 11, a rotating mass energy store 13, 14 is now provided and preferably includes a rotating mass 14 coupled to a synchronous machine 13. The synchronous machine 13 operates at the 6 kV level and is connected via a transformer 12 to the 220 kV level. The rotating mass energy store 13, 14 can also, by means of suitable generator switches G2, G3, selectively draw power via the AC/DC converter 15 from the central DC branch 19 or supply power via the rectifier bridge 16 to the central DC branch 19. A direct connection between the rotating mass energy store 13, 14 and the power supply network 11 can be provided by switches N3 and G1.

A first operating mode of the installation 10 is shown in FIG. 1. With the switches N1, . . . , N3 and G1, . . . , G3 set as shown, the power supply network 11 is connected via the rectifier bridge 16 to the central DC branch 19 and supplies real power P (arrow in FIG. 1) to the branch. The rotating mass energy store 13, 14 is also connected directly to the power supply network 11 and supplies a compensating wattless power Q (arrow in FIG. 1) to the network.

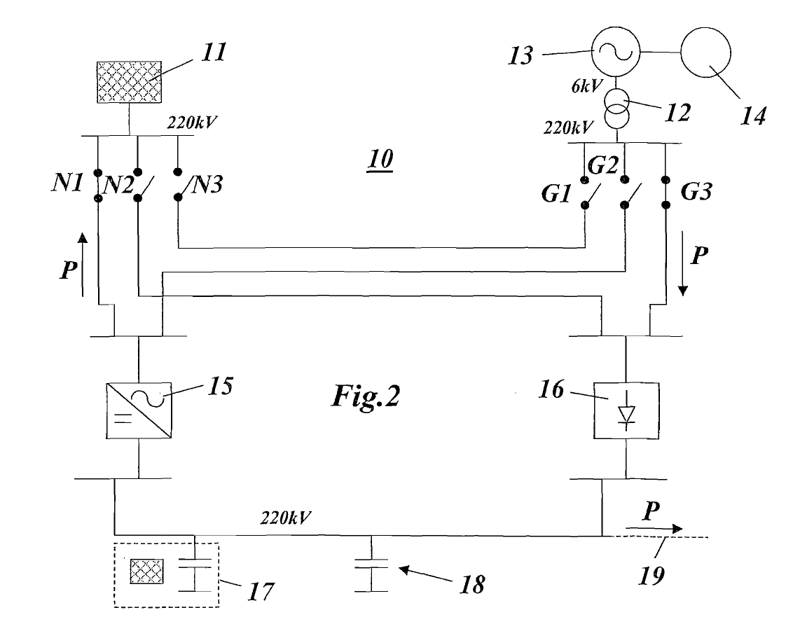

In the operating mode shown in FIG. 2, the rotating mass energy store 13, 14 supplies real power P via the rectifier bridge 16 to the central DC branch 19 while the power supply network 11 draws real power P via the AC/DC converter 15 from the central DC branch 19.

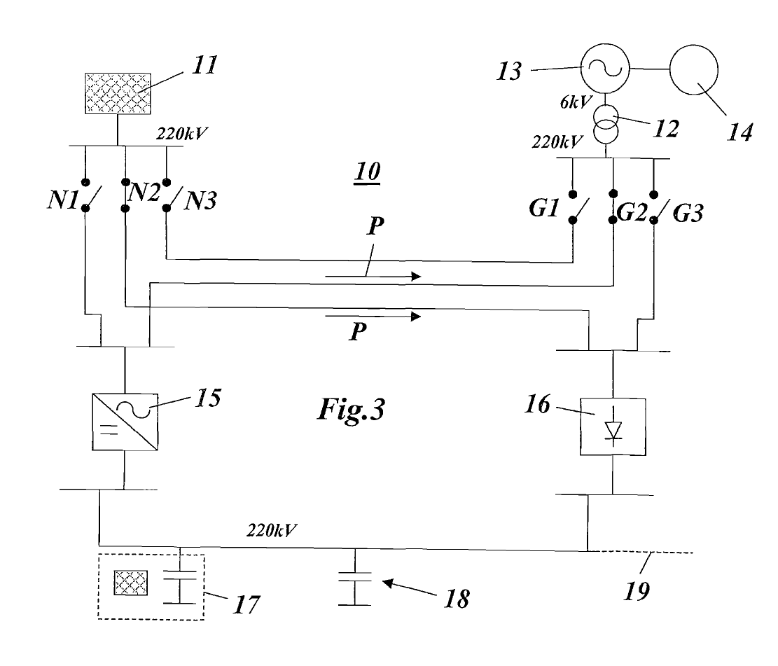

In the operating mode shown in FIG. 3, the rotating mass energy store 13, 14 receives real power P via the AC/DC converter 15 from the central DC branch 19. This receives (as shown) real power via the rectifier bridge 16 from the power supply network 1I1 or from other (not illustrated) DC branches.

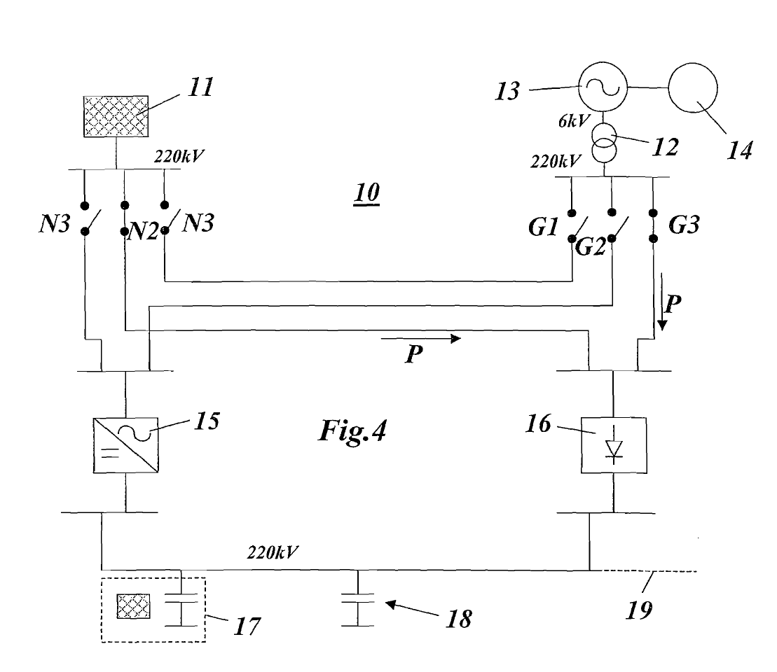

In the operating mode shown in FIG. 4, both the power supply network 11 and the rotating mass energy store 13, 14 supply real power P via the rectifier bridge 16 to the central DC branch 19.

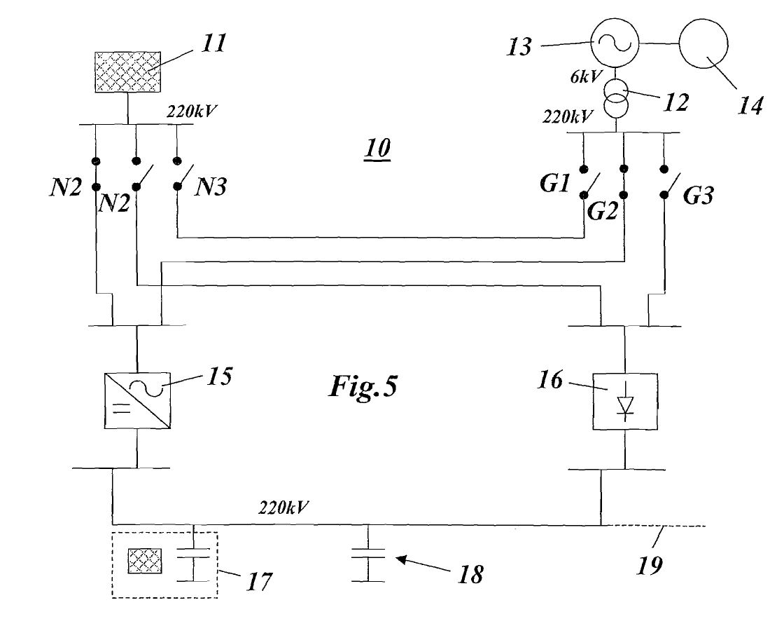

Finally, in the operating mode shown in FIG. 5, the central DC branch 19 supplies both the power supply network 11 and the rotating mass energy store 13, 14 via the AC/DC converter 15.

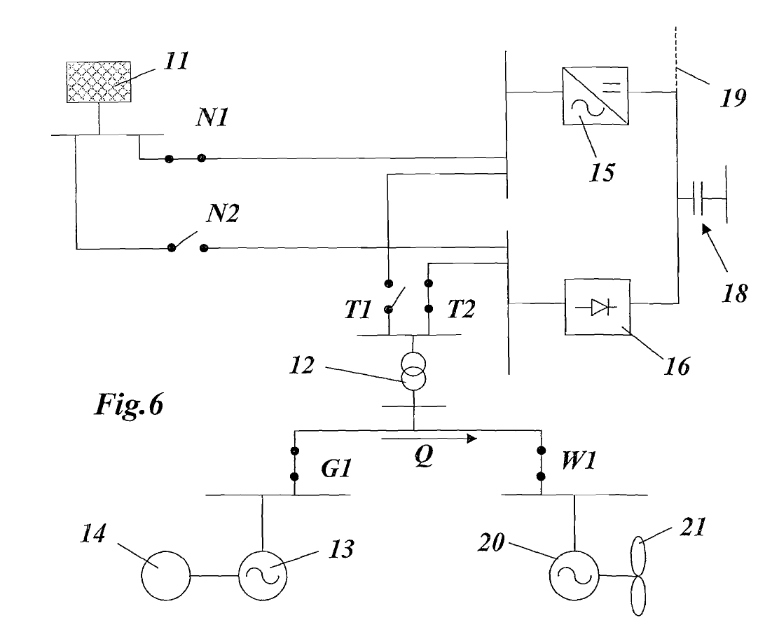

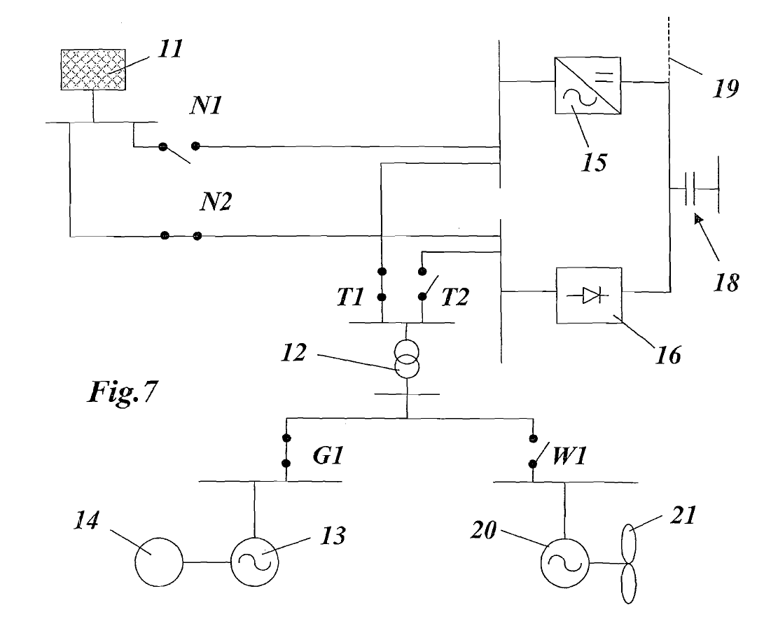

Use in accordance with the invention of a rotating mass energy store in conjunction with wind-energy generation in a wind farm or similar is of particular significance. FIGS. 6 and 7 show one appropriate configuration of the electrical installation with at least one wind-energy installation 20, 21, comprising an asynchronous machine 20 and a wind turbine 21, being provided. The power supply network 11 can in turn, by using network switches N1, N2, be selectively connected via the rectifier bridge 16 or the AC/DC converter 15 to the central DC branch 19. Similarly, the rotating mass energy store 13, 14 can be selectively connected, by using switches T1, T2, via the rectifier bridge 16 or the AC/DC converter 15 to the central DC branch 19. By means of switches G1 and W1, the wind-energy installation 20, 21 and the rotating mass energy store 13, 14 can be connected in parallel. It is thus possible for the power electronics to reduce the energy distribution both from the power supply network 11 and into the power supply network 11.

In the operating mode shown in FIG. 6, the rotating mass energy store 13, 14 supplies wattless power Q to the wind-energy installation 20, 21. The frequency of the rotating mass energy store 13, 14 and also that of the wind-energy installation 20, 21 can be adjusted, so that power fluctuations are reduced before the power supply network 11 must be connected in support.

In the operating mode shown in FIG. 7, the rotating mass energy store 13, 14 is started via the AC/DC converter 15 (switches T1 and G1 closed) before it is connected to the wind-energy installation 20, 21 (FIG. 6).

The rotating mass energy store 13, 14 can additionally be optimized in order to better fulfil the tasks occurring within the scope of the invention. For example, it is possible to reduce the air pressure around the rotating mass in order to reduce ventilation losses and increase the energy storage efficiency.

It is also possible to use frequencies for the rotation of the masses that enable the rotating mass energy store to be connected directly to the power supply network and thus achieve power factor corrosion.

The rotation frequencies of 2- or 4-pole generators can also be used to reduce the masses required for storage.

Finally, the electrical installations according to the invention can be provided with AC/DC converters and rectifier bridges that operate at a low voltage level. In this case, the central DC branches can be connected to each other by superconductors.

1. An electrical installation comprising:
a power supply network;
at least one of an AC/DC converter and a rectifier bridge;
a central DC branch, wherein the power supply network is connectable to the central DC branch selectively via one of the AC/DC converter and the rectifier bridge; and
a rotating mass energy store selectively connectable directly to the power supply network or to the central DC branch via one of the AC/DC converter and the rectifier bridge.

2. The electrical installation as recited in claim 1, wherein the central DC branch is part of a DC network.

3. The electrical installation as recited in claim 1, wherein the rotating mass energy store includes a rotating mass selectively coupled to a synchronous machine operating as one of a motor and a generator.

4. The electrical installation as recited in claim 1, further comprising a plurality of switches for selectively connecting the power supply network and the rotating mass energy store to each other and to the central DC branch.

5. The electrical installation as recited in claim 3, further comprising transformer disposed between the synchronous machine on a first side and the supply network and the central DC branch on a second side.

6. The electrical installation as recited in claim 1, further comprising a plurality of smoothing capacitors disposed at an output of the rectifier bridge.

7. The electrical installation as recited in claim 1, further comprising a DC energy store element connected to the central DC branch.

8. The electrical installation as recited in claim 7, wherein the DC energy store element includes at least one of a superconducting coil and a capacitor bank.

9. The electrical installation as recited in claim 1, further comprising a wind-energy installation selectively connectable to the rotating mass energy store and disposed in parallel with the rotating mass energy store.

10. The electrical installation as recited in claim 9, wherein the wind-energy installation includes a wind turbine coupled to an asynchronous machine.

11. The electrical installation as recited in claim 9, further comprising a plurality of further switches for selectively connecting the wind-energy installation to the rotating mass energy store.

12. A method for operating of an electrical installation having a power supply network connectable to a central DC branch selectively via one of an AC/DC converter and a rectifier bridge, the method comprising:
selectively connecting a rotating mass energy store according to a status of the power supply network to the central DC central branch via one of the AC/DC converter and the rectifier bridge and directly to the power supply network.

13. The method as recited in claim 12, wherein the rotating mass energy store supplies wattless power to the power supply network and the power supply network supplies real power via the rectifier bridge to the central DC branch.

14. The method as recited in claim 12, wherein the rotating mass energy store supplies real power via the rectifier bridge to the central DC branch, and wherein the central DC branch supplies real power via the AC/DC converter to the power supply network.

15. The method as recited in claim 12, wherein the central DC branch supplies real power via the AC/DC converter to the rotating mass energy store, and the power supply network supplies real power via the rectifier bridge to the central DC branch.

16. The method as recited in claim 12, wherein both the power supply network and the rotating mass energy store supply real power via the rectifier bridge to the central DC branch.

17. The method as recited in claim 12, wherein the central DC branch supplies real power via the AC/DC converter to both the power supply network and the rotating mass energy store.

18. The method as recited in claim 12, further comprising connecting a wind-energy installation selectively to the rotating mass energy store and in parallel with the rotating mass energy store so that the rotating mass energy store supplies wattless power to the wind-energy installation.

19. The method as recited in claim 12, further comprising connecting a wind-energy installation selectively to the rotating mass energy store and in parallel with the rotating mass energy store and starting the rotating mass energy store using the central DC branch via the AC/DC converter and then connecting the rotating mass energy store to the wind-energy installation.
